(19) United States
(12) Patent Application Publication
(10) Pub. No.: US 2011/0198274 A1
(43) Pub. Date: Aug. 18, 2011

(54) FILTER FOR FUELS AND LUBRICANTS

(76) Inventor: Horst Weiland, Waldbrunn (DE)

(21) Appl. No.: 13/063,523

(22) PCT Filed: Sep. 8, 2009
(86) PCT No.: PCT/DE2009/001262

§ 371 Date: May 3, 2011

(30) Foreign Application Priority Data
Sep. 12, 2008 (DE) 102008046952.1

(51) Int. Cl. B01D 35/34; B01D 39/16

(52) U.S. Cl. 210/232; 210/490; 210/457

(57) ABSTRACT

A filter for fuels and lubricants for use in engines, such as internal combustion engines, includes a vessel having an inlet and an outlet for fuels, lubricants and other fluids, which contains a multiplicity of layers of a thin, non-woven fabric. The non-woven fabric includes in a first part made of permanently elastic fibers and, in a second part, flexible, soft strips, which are at least twice as wide as the permanently elastic fibers and with the average distance between the fibers and the strips being a multiplicity of the width of the flexible, soft strips.

The invention relates to a filter for internal combustion engines and other machines, which comprises a vessel with an inlet and an outlet for fuels, lubricants and other fluids and is filled with a multiplicity of layers of a thin non-woven fabric.

In combustion engines and other machines with moving mechanical elements, metal slides or rolls against metal and against other materials. Spectacular applications are the pistons of a combustion engine, which slides over the wall of the cylinder, the bearing of the connecting rod on the crankshaft and the bearing of the crankshaft in the engine block, which all require lubrication for an acceptable lifetime.

Despite this lubrication, material fatigue continually results in abrasion particles, which in many cases are sharply edged, at the surface. Similarly disadvantageous effects are produced by small soot particles, since they are also very sharp edged. If these sharp-edged, extremely small particles come between two metal surfaces sliding or rolling on one another, they can break further particles out of one of the surfaces, and thereby generate increased wear.

To minimize this wear as far as possible, filters are used in the oil circuit, which are intended to hold back the particles and other contaminants.

In the main stream of oil circuit of combustion engines, filters are mostly used that consist of only one layer of a planar filter, which is often produced with a thickness of about 2 mm.

For a maximum flow rate of the oil to be filtered, the biggest possible surface area of the filter material is necessary, which, by concertina folding, is reduced to such small dimensions that it is installed in a—mostly cylindrical—vessel, which is interposed in the main stream.

The decisive disadvantage of this filter is that it only holds back contaminants larger than 10 microns. Unfortunately, the often very sharp-edged particles—such as soot particles with sizes between 1 micrometers and 10 micrometers remain in the oil and—as mentioned above—cause increased abrasion by breaking out other particles.

Another disadvantage is that such filters cannot hold back water that is dissolved in or floating on the oil.

In the prior art, filters of pulp are also known, which is rolled from numerous fibres to form a thin pulp cloth and, in one or more laminated layers, oil flows through it. They are also occasionally used in the side-stream filters of large combustion engines, such as ship engines.

German patent DE 87 00 995, Richard Freiwald, describes an oil filter, whose filter layer consists of rolled up pulp. In the interior of the cylindrical pulp roller, a tube guides the lubricant flow. The housing of the filter is also cylindrical in construction and guides the lubricant on the outer surface of the cylindrical filter layer.

Contrary to the appearance that an ideal lubricant should be absolutely particle free, particles with a size below 1 micrometer even act as wear-reducing additives, since they get lodged in rough areas and extremely fine notches on the surface to be lubricated, and thereby smoothen it. Thereby the lubrication capacity and heat resistance of the oil is significantly improved in comparison to the fresh oil.

Against this background, it is the object of the invention to develop a filter that holds back considerably finer particles than in the prior art, however allows even smaller particles to pass through in the largest possible number. A particularly interesting boundary between the particles that are still held back and those that are allowed to pass through is about 1 micrometer diameter.

As a solution, the invention presents the fact that the nonwoven fabric consists, in a first part, of permanently elastic fibers and, in a second part, of flexible, soft strips, which are at least twice as wide as the fibers, and the average distance between the fibres and the strips is a multiplicity of the width of the strip.

The filter material according to the invention consists, in part, of flexible soft strips, such as pulp, which has already proven its value as a material for filters. In particular, somewhat larger particles are trapped by the soft pulp fibers and are caught therein. Due to the subsequently injected oil and due to further incident particles, the particles, once trapped, are forced further into the pulp and are thereby safely trapped and held back. This effect of gradual densification of the pulp fibers occupied with trapped particles is advantageous for retaining particles once they are trapped, but disadvantageous for the capability of receiving, in particular, small particles.

Of the laden and firmly intertangled pulp regions, in particular, the smaller particles are diverted into other pulp areas, which are not yet laden with particles. Here, too, however, they are only trapped if the pulp fibers are as yet almost entirely unladen and uncharged with other particles. The multiplicity of the particles with diameters below 1 micrometer are therefore not retained, but entrained in the oil stream through the pulp nonwoven fabric.

The characterizing feature of the invention, in contrast to filters only of pulp fibres, is the permanently elastic, narrow fibres in the filter nonwoven fabric between almost all pulp strips. If such a pulp strip has trapped a particle, it would—as explained above—roll up ever further without the effect of the permanently elastic fibers, and thereby, though retaining the particles effectively, would make it difficult to receive further particles.

The adjacent, permanently elastic fibers ensure that the pulp strip, after trapping a particle, is for the most part pushed back to its original position, so that no increasing pulp densifications may form.

In particular, in the manner, a minimum distance between the strips and the fibers is maintained. If the permanently elastic fibers have a diameter between 10 micrometers and 25 micrometers, and the flexible soft strips have a width between 20 and 50 micrometers, particles with a diameter below about 50 micrometers down to about 1 micrometer are trapped, however even smaller particles with a diameter below 1 micrometer are allowed to pass through. Due to these small particles, the lubricant even gains in benefit for the engine or the machine, since, as mentioned, particles of this size lodge in small notches and depressions, thereby smoothen them further and so act as an additive that can further improve the lubricity of oil, even above the lubricity of the original fresh oil.

The term “nonwoven fabric” is intended to mean, in the most general case, all the fibers and strips randomly twisted together. If the fibers are oriented entirely stochastically, such a material is termed a random nonwoven fabric. For a filter according to the invention, nonwoven fabrics are also suitable in which the fibers and stripes are deposited in a defined way in a preferred direction. It is also possible to use nonwoven-like materials partly comprising regularly interwoven fibers and/or strips. It is essential for each variant that both permanently elastic fibers and soft, flexible strips are contained.

In an advantageous embodiment, both the permanently elastic fibers and the flexible, soft strips are almost entirely curved in profile within the nonwoven fabric and are only straight for relatively short sections.

To keep the nonwoven fabric's storage capacity for particles as high as possible, it is appropriate that the average distance between the fibers themselves and between the fibers and the strips is in each case greater than approximately four times the width of the strips. Here, the term “average distance” means that the fibers, among themselves, the fibers and the strips, as well as the strips among themselves are in contact and also closer together at certain points, but at other points have a relatively large distance from one another. This means the average of the distance over the entire length.

In a further variant, the average distance at, at least, one point is more than eight times the width of the strips. If this condition is met, ever larger gaps form in the nonwoven fabric, which offer even relatively large particles a space in which they can be trapped.

During the transition from moving to stationary, the particles lie on a particular number of permanently elastic fibers and another number of flexible soft strips. The permanently elastic strips store the kinetic energy transmitted by the incident particles and transfer a large portion of it back to the particle in a similar way to a spring, so that it moves back by a very small distance. However, flexible, soft strips only follow this backward movement where they directly bear against the particles. In the other regions, they only follow the backward movement to a much lower extent than the fibers, so that a multiplicity of gaps and slits form, through which particles with a size of about 1 micrometer and smaller can pass.

The flexible soft strips bear against the particle at certain points and—at other points—also on the permanently elastic, thin fibres. By this means they act, in principle, like a network that is stretched between two poles and thereby allow the liquid to pass through, but not the objects entrained in this stream. This also explains the significantly improved and optimized filterability of the nonwoven fabric according to the invention in comparison to other known nonwoven fabrics that only consist of a single sort of fibers.

Suitable materials for the permanently elastic fibres include plastics such as polypropene, also known as polypropylene. These hydrocarbon compounds have been known since 1951 and are produced as a thermoplastic from the group comprising polyolefins in various forms and embodiments, inter alia, also in the very thin fibres required here. In 2001, approximately 30 million tons of polypropylene were produced worldwide.

Another very highly suitable material is polyester, a polymer with ester bonds in its main chain. Such plastics have been known since 1830 and are produced and used in various embodiments. The application range extends from films through beverage bottles to the strings of tennis racquets. The material can therefore also be very readily used for the permanently elastic fibers of the nonwoven fabric according to the invention.

For the flexible soft strips of the nonwoven fabric according to the invention, pulp is very readily suitable, in this case particularly in elongated strips that are at least twice as wide as the permanently elastic fibers. Pulp is produced by the chemical digestion of plant fibers, particularly wood. It consists predominantly of cellulose and is produced in large quantities particularly for paper production. The fibers are of significantly lower elasticity than the above-mentioned plastic fibers, that is to say, in contrast to these, soft and flexible, particularly such fibers or a plurality of inter-bonded fibers are preferred, which form a “strip,” and are thus very much wider in cross-section than in height. In particular, in this configuration, they act as arrester nets, which are stretched between the elastic fibers.

Since the permanently elastic fibers should preferably have a diameter between 10 micrometers and 25 micrometers, and the flexible soft strips should be at least twice as wide, this results in a width between 20 micrometers and 50 micrometers. The preferred width, however, is four times the fiber thickness, that is to say 40 micrometers to 100 micrometers.

For other applications, in which the particles with larger diameters of up to about 25 to 30 micrometers are to pass through the filtering nonwoven fabric, a thickness of the fibers between 15 micrometers and 50 micrometers is suitable.

For the nonwoven fabric, a thickness of about 1 mm is preferred, in particular conjunction with fibers between 10 micrometers and 25 micrometers. These dimensions are particularly suitable for lubricant filters in combustion engines and other machines, because they hold back particles down to a diameter of 1 micrometer, but allow smaller particles with a diameter below 1 micrometer to pass through and thereby even further increase the lubrication effect. Depending on the manufacturing process of the nonwoven fabric, nonwoven fabric thicknesses of 0.5 to 2.5 millimeters can also be used.

Provided that the manufacturing process ensures that the properties of the nonwoven fabric correspond homogeneously to the conditions of the main claim, even with relatively large material thicknesses, even thicker nonwovens with a thickness of at least ¾ mm, are appropriate.

To allow the nonwoven material according to the invention to be used as filter, it is embedded in a vessel that is provided with an inlet and an outlet for the liquid to be filtered.

In an advantageous embodiment, the filter consists of a perforated hollow cylinder that is connected to an outlet opening of the filter, and on which the nonwoven is wound in multiple layers, so that it forms a further hollow cylinder. This arrangement can be easily produced from thin webs of a nonwoven by winding. Since the nonwoven web can be relatively easily checked at all points before winding, it is thus ensured that the nonwoven layer is homogeneous over all layers. Another advantage is that the thickness of the filter layer can be easily adjusted to tolerance due to the winding.

It is also advantageous that the inlet surface into the nonwoven layer is very much larger than the outlet surface. As a result, at the beginning of filtering, when the liquid is still contaminated by a multiplicity of particles, the flow velocity is low, because the liquid volume is distributed over a large surface. As a result even relatively large particles can be caught in the nonwoven fabric without being entrained by too high a flow velocity.

With increasing depth of the penetration in the nonwoven layer, the number and diameter of the particles still present continues to decrease. Deep in the interior, close to the perforated hollow cylinder the flow rate is highest and the number and diameter of the particles still being transported is lowest. Ultimately, only the—welcome—small particles with a maximum size remain. This maximum size is 1 micrometer for combustion engines and other machines.

Another, very advantageous property of the nonwoven fabric according to the invention is its capability to store water. Water content reduces the lubricity of oil so significantly that excessive wear or even damage can occur. Water content in the fuel causes non-uniform, intermittent combustion, as a result of which the pollution component is increased and the true running of a combustion engine is impaired. The nonwoven fabric according to the invention absorbs water in and between the capillaries of the pulp. On the other hand, very numerous fine water droplets are also included between the fibres of the nonwoven fabric and stored in pocket-like, mutually touching fibres and in folds or flexible soft strips.

In a particularly effective variant, the wall of the perforated hollow cylinder in the interior of the filter consists of a tubular mesh. The hollow cylinder can be formed from a flat mesh into a hollow cylinder by rolling up or produced immediately in the first step as a three-dimensional tubular structure by weaving and/or welding together, e.g., multiple wires or by casting or pressing a hollow cylindrical plastic network. A tube is also conceivable in the wall of which numerous openings have been punched.

It is to be noted that, in any case, directly in front of these openings or in front of the meshes of a network of the interior hollow cylinder within the nonwoven fabric, a conical region forms in which particles are deposited. The regions between these cones, that is to say the nonwoven fabric on the bridges of the mesh-shaped hollow cylinder remains unused for depositing the particles to be filtered out. The smaller the number of bridges, the greater is the proportion of the nonwoven fabric that can be used for particle deposition.

In the embodiment described above, not only the innermost perforated hollow cylinder but also the nonwoven fabric wound thereon forms a cylindrical body. It is therefore also appropriate to form the vessel as a hollow cylinder. An interesting embodiment is a pot-shaped contain that is open at one end face. If, at the edge of this opening, a screw thread is introduced into the wall, a lid can be screwed on as closure of the vessel. Unlike known designs of a vessel with a projecting flange, such a screw lid takes up considerably less space in the machine.

In this embodiment, the inlet and outlet for the liquid to be filtered can in each case be arranged on an end face of the vessel. If, for example, the lid, in its center, supports the perforated hollow cylinder, on which the filter nonwoven fabric is wound, then the inlet nozzle can be arranged on the fixed end face of the hollow cylindrical vessel.

In another embodiment, both the inlet and the outlet are arranged in the lid; in this case, the inlet and outlet are so close together that the filter can be easily inserted into an existing line.

Another advantage is that, to increase the flow rate, the cylindrical nonwoven body and, in its core, the perforated hollow cylinder only needs to be cut off from the starting material to the necessary length, with the diameter remaining uniform.

As an alternative embodiment for the extension of the pot-like vessel, a tubular piece that has been cut to fit and is closed by a lid at the other end can be screwed onto the lid.

With this design, it is advantageous that a disk, which blocks the passage of the liquid to be filtered, is mounted or pressed on the end faces of the cylindrically wound nonwoven fabric in each case. This disk can be made of metal, plastic, microfibers or other material that is impermeable for the liquid to be filtered. By this means it is achieved that the entire liquid to be filtered passes through all layers of the nonwoven fabric and only then can leave the filter layer through the internally arranged perforated tube. A “short circuit,” bypassing the filter layer, directly into the outlet is thereby blocked.

From the point of view of its mechanical construction, a nonwoven fabric according to the invention, which filters the particle down to a minimum size of about 1 micrometer, in the application in combustion engines, is suitable both for filtering the fuel and for filtering the lubricant, since the advantageous effect of the improved lubrication effect due to entrained very small particles of maximum 1 micrometer in size applies to all mechanical areas. If both the permanently elastic fibers and the flexible soft strips are just as chemically resistant to fuel as to lubricant, identical filters can be used for both functions.

A filter according to the invention is also suitable for filtering hydraulic oil in hydraulic systems.

One of the most frequent fields of application will be the oil circuit of engines and machines. A filter according to the invention is particularly suitable for fitting in a bypass of the oil circuit. An appropriate combination is a standard oil filter in the main stream, which permits a large volume of the lubricant to pass through, but only filters coarsely down to 10 micrometers and a filter according to the invention in the bypass stream for filtering out in particular particles of 10 micrometers to 1 micrometer.

Further details and features of the invention are explained below in greater detail with reference to examples. This is not intended to restrict the invention, but only to explain it. In schematic view,

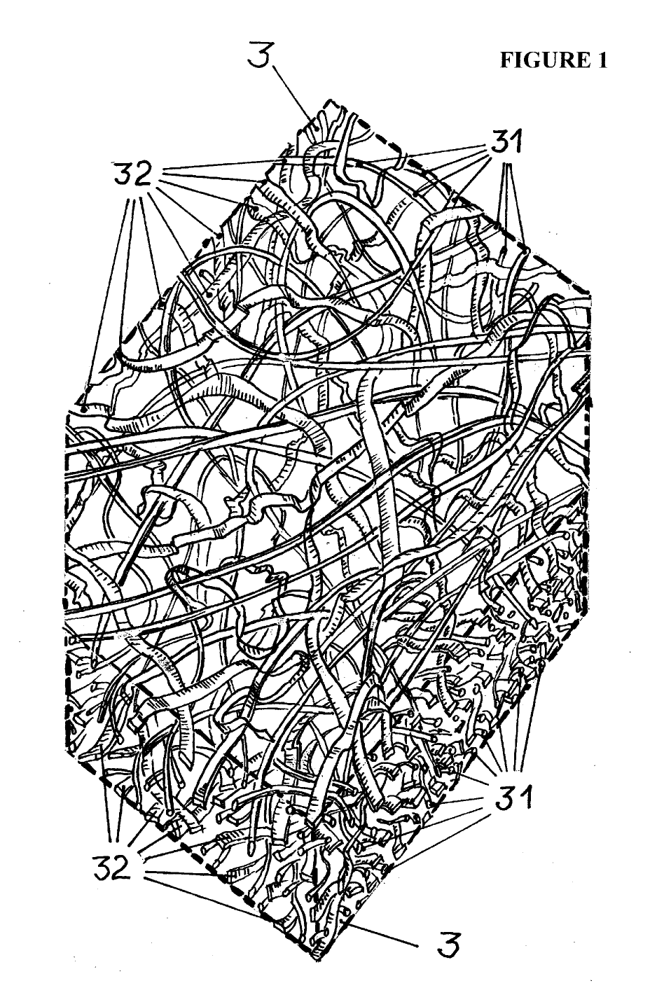

FIG. 1 shows, microscopically enlarged, an octagonal portion of a nonwoven fabric;

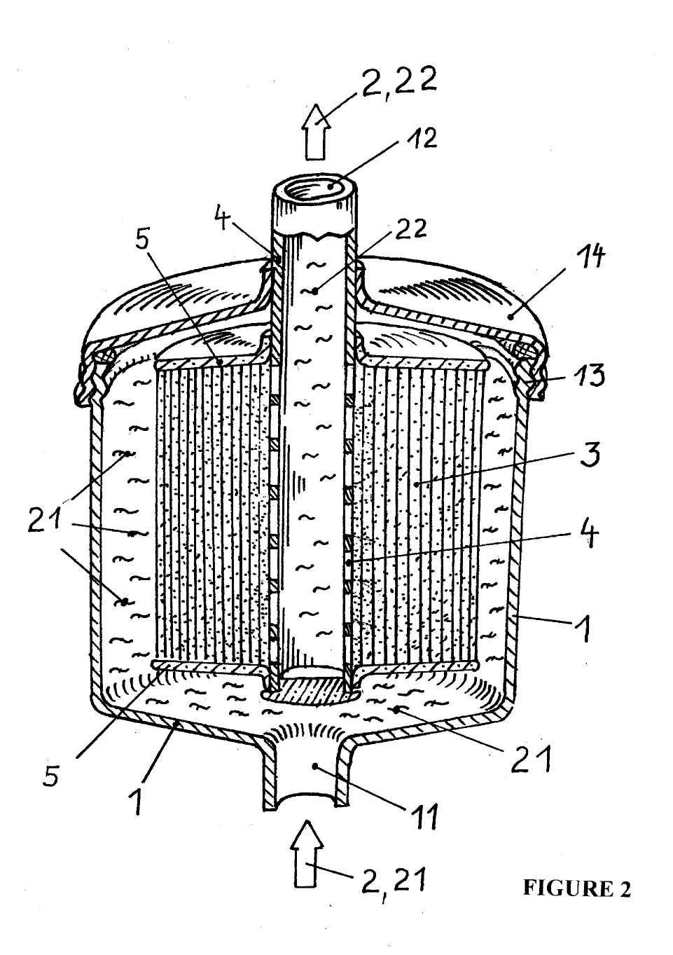

FIG. 2 shows a longitudinal section through a complete filter.

In FIG. 1 a very small octagonal portion of the nonwoven fabric 3 according to the invention is drawn in a microscopic view. In this embodiment, the fibers, in their orientation, are distributed stochastically over the nonwoven fabric, so that it can be classified as a so-called “random” nonwoven fabric. The main feature of the invention is very clear, namely, the combination of permanently elastic fibers 31 with the flexible soft strips 32. In FIG. 1 it is clear that the permanently elastic fibers 31 after the collision with a particle, springs back to its original form with a considerably higher recovery force than the flexible soft strips 32.

A further feature of the invention, which is also clearly apparent in FIG. 1, is that the flexible, soft strips are wider than the permanently elastic fibres 31. In FIG. 1, it can be readily seen that the flexible soft strips 32 bend transversely to their longitudinal axis with very small radii of curvature, and can even crumple. This material property is represented in FIG. 1 by means of small strokes transversely to the longitudinal axis of the strip.

In FIG. 1, it can be seen that, in the region of the cut edge of the illustrated nonwoven fabric 3, that the strips 32, which are drawn in section, have an elongated rectangular cross-section and the fibers 31 have a circular cross-section. Since these fibers 31 are generally produced by extrusion, that is to say forcing liquid material through a close-tolerance die and subsequent solidification, their profile is circular over the entire length in the drawn embodiment. The fibers 31 curve in their path, as can be clearly see, for example, in the upper region of FIG. 1, with very much large radii of curvature than the strips 32.

In FIG. 1, it can be clearly seen how even relatively large particles are caught and retained by the relatively soft and flexible strips 32 in that a caught particle is in contact with the strips 32 over much longer sections than with the permanently elastic fibers 31. The latter usually contact the particles only at one or two points and only exceptionally on a line.

The permanently elastic fibers 31 always push back a particle by a certain amount after an impact, so that small gaps and openings develop between the particle and the permanently elastic fibers 31. These openings serve as a passage for very small particles with diameters of less than 1 micrometer, which are very welcome to increase the lubricity because they lodge in irregularities in the surface to be lubricated.

In FIG. 1, however, the improved retention for particles between about 1 micrometer and 10 micrometers in size can be seen in comparison to a pure pulp nonwoven fabric. The flexible, soft pulp strips 32 are held by the permanently elastic fibers 31 and tensioned thereby. They do not clump with one another but are tensioned between two fibers 31 like an arrester net.

FIG. 2 shows an embodiment of a filter according to the invention in rotationally symmetric design cut open lengthways. At the lower end of the approximately pot-shaped vessel 1 is the inlet 11 for allowing the lubricant 2 to flow in, which can be seen here as a lubricant 21 still to be filtered.

The lubricant 21 still to be filtered then fills the interior space of the vessel 1. It enters the nonwoven fabric 3, which in this embodiment is wound to form a cylinder, which is shown cut lengthways in FIG. 2. In the cut plane of the cylindrical nonwoven fabric roll, the individually cut layers of the nonwoven fabric can be readily seen. The points in each layer of the nonwoven fabric 3 show that many particles have already become trapped in each layer of the wound nonwoven fabric.

In FIG. 2, it can be easily seen that the lubricant 21 still to be filtered penetrates further into the interior from the outer surface of the nonwoven fabric 3 that is wound to form a hollow cylinder. The lubricant 2 leaves behind increasingly more of the particles entrained in it in the nonwoven fabric 3. At the end of its path through the nonwoven fabric, it encounters the openings in the perforated hollow cylinder 4 and passes through these openings into the interior space of the hollow cylinder 4, and from there through the outlet 12 at the top of the lid 14 that is screwed on the vessel 1, outwards for further use.

In FIG. 2, it can be readily seen in the cross-section that no particles are deposited in the nonwoven fabric in the regions in front of the bridges of the perforations of the hollow cylinder 4, but all the more so in the region of the openings. However, advantageously, these cones are so small that they only extend into two of the illustrated layers. Therefore, in FIG. 2, it can be seen that, in comparison to the prior art, the fine perforation according to the invention of the hollow cylinder 4, in comparison to only one or two openings, ensures that most of the nonwoven fabric is also used for depositing particles to be filtered out, which is illustrated in FIG. 2 by means of numerous points in the nonwoven fabric 3.

FIG. 2 shows, as an alternative embodiment, one disk 5 on both end faces of the cylindrical wound nonwoven fabric 3. It is clear to seen that these two disks block a shortcut of the lubricant 21 still to be filtered through the interior region of the end faces directly into the hollow cylinder 4.

In FIG. 2, the lubricant 21 still to be filtered is illustrated by means of a multiplicity of small waves with small cross strokes. It is located in the inlet 11 and in the interior of the vessel close to the outer wall thereof.

Filtered lubricant 22 can only be found in the interior of the hollow cylinder 4 and in the outlet 12. The successful filtering is shown by the omission of the small cross-stroke of the wave-like symbol.

### LIST OF REFERENCE CHARACTERS

1 Vessel, filled with the nonwoven fabric 3 for filtering the lubricant 2
11 Inlet of the vessel 1 for the unfiltered lubricant 2
12 Outlet of the vessel 1 for the filtered lubricant 2
13 Thread on the upper edge of the vessel 1
14 Lid for sealing the vessel 1
2 Lubricant to be filtered through the nonwoven fabric 3
21 Lubricant 2 to be filtered
22 Filtered lubricant 2
3 Nonwoven fabric in the vessel 1 for filtering the lubricant 2
31 Permanently elastic fibres of the nonwoven fabric 3
32 Flexible soft strips of the nonwoven fabric 3
4 Hollow cylinder, perforated, in the core of the vessel 1
5 Disk on the end face of the cylindrically wound nonwoven fabric 3

1-21. (canceled)

22. A filter for an internal combustion engine, comprising:
a vessel having an inlet and an outlet for fuels and lubricants, said vessel containing a multiplicity of layers of a thin, non-woven fabric having a first part having permanently elastic fibers and a second part having flexible, soft strips with said flexible, soft strips having a width that is at least twice a width of said permanently elastic fibers, and with an average distance between said permanently elastic fibers and said flexible, soft strips being a multiplicity of the width of said flexible, soft strips.

23. The filter for an internal combustion engine according to claim 22, wherein said permanently elastic fibers and said flexible, soft strips have a substantially curved profile.

24. The filter for an internal combustion engine according to claim 22, wherein the average distance between said permanently elastic fibers and said flexible, soft strips is greater than four times the width of said flexible, soft strips.

25. The filter for an internal combustion engine according to claim 22, wherein the average distance between said permanently elastic fibers and said flexible, soft strips at, at least, one point is greater than eight times the width of said flexible, soft strips.

26. The filter for an internal combustion engine according to claim 22, wherein the width of the flexible, soft strips is four times a thickness of said permanently elastic fibers.

27. The filter for an internal combustion engine according to claim 22, wherein said permanently elastic fibers are made of a plastic selected from the group consisting of polyester, polypropene and a combination thereof.

28. The filter for an internal combustion engine according to claim 22, wherein said flexible, soft strips are made of pulp.

29. The filter for an internal combustion engine according to claim 22, wherein a thickness of said permanently elastic fibers is between 10 micrometers and 25 micrometers.

30. The filter for an internal combustion engine according to claim 22, wherein a thickness of said permanently elastic fibers is between 15 micrometers and 50 micrometers.

31. The filter for an internal combustion engine according to claim 22, wherein said non-woven fabric has a thickness of about 1 mm.

32. The filter for an internal combustion engine according to claim 22, wherein said non-woven fabric has a thickness in a range of about 0.5 mm to 2.5 mm.

33. The filter for an internal combustion engine according to claim 22, further comprising a perforated hollow cylinder within said vessel and connected to said outlet thereof and upon which said non-woven fabric is wound in a plurality of layers.

34. The filter for an internal combustion engine according to claim 33, wherein said vessel is formed as a hollow cylinder.

35. The filter for an internal combustion engine according to claim 34, wherein one end of said vessel is open and includes a screw thread for screwing thereon a lid for sealing said vessel.

36. The filter for an internal combustion engine according to claim 35, wherein said lid, said inlet and said outlet are arranged for adapting to a required rate of flow of fluid and further comprising more than one said perforated hollow cylinder within said vessel with said non-woven fabric being wound thereon, said vessel being closed on said one end with said lid and at an opposite end of said vessel with an additional lid.

37. The filter for an internal combustion engine according to claim 22, wherein said perforated hollow cylinder has a wall formed as a grill.
